(19) United States
(12) Patent Application Publication
(10) Pub. No.: US 2021/0209629 A1
(43) Pub. Date: Jul. 8, 2021

(54) CONTINUOUS UPDATING OF PREDICTED EVENT OUTCOMES USING REAL-TIME AUDIENCE BEHAVIOR

(71) Applicant: ADOBE INC., San Jose, CA (US)

(72) Inventors: Niranjan Shivanand Kumbi, Fremont, CA (US); Ajay Awatramani, Fremont, CA (US); Vaidyanathan Venkatraman, Fremont, CA (US); Omar Rahman, San Jose, CA (US); Kai Yeung Lau, Seattle, WA (US)

(21) Appl. No.: 16/732,678

(22) Filed: Jan. 2, 2020

(51) Int. Cl. G06Q 30/02; G06Q 10/02

(52) U.S. Cl. CPC G06Q 30/0204; G06Q 10/02; G06Q 30/0269; G06Q 30/0201

(57) ABSTRACT

An improved analytics system generates predicted event outcomes for events. The analytics system generates expected registration profiles based on event metadata that indicates predicted audience behavior for an event. This expected registration profile is used to analyze real-time audience behavior of an audience associated with the event. A predicted event outcome can be determined that indicates a time-based conversion propensity related to the audience.

### BACKGROUND

Business intelligence or analytics systems are computer-based systems that collect and analyze data related to customers. Such analytics systems can provide insight about customers, products, and/or business trends based on analyzed data. Analytics systems are often used to provide targeted digital content (e.g., emails, invitations, etc.) to prospects (e.g., prospective customers/consumers). In particular, targeted digital content can be related to various events types (e.g., in-person events, executive roundtables, trade shows, and webinars).

Conventional systems often rely on targeting large numbers of prospects to invite to events (e.g., in the hope that enough prospects have been invited to an event to meet an event attendance goal). These systems operate based on a general understanding that only a percentage of invited prospects will attend an event. In identifying if enough of the invited prospects will register for the event, conventional systems are typically reactive and slow. In particular, after sending invitations to the large number of invited prospects, conventional systems typically wait for responses to determine how many of the invited prospects plan to attend the event. For example, after waiting several weeks for responses to invitations, a marketer may determine that too few have accepted or registered for the event. At this point, conventional systems require a reaction to the low registrations. Unfortunately, reacting at this point can be too late in the process to efficiently target additional prospects, resulting in a waste of resources.

### SUMMARY

Embodiments of the present disclosure are directed towards an improved analytics system that generates predicted event outcomes for events. Such a predicted event outcome can be based on a likelihood of meeting an attendance goal set for the event. In accordance with embodiments of the present disclosure, the analytics system generates expected registration profiles based on event metadata that indicates predicted audience behavior for an event. This expected registration profile is used to analyze real-time audience behavior of an audience associated with the event. A predicted event outcome can be determined that indicates a time-based conversion propensity related to the audience. Analyzing the real-time audience behavior using the expected registration profile enables the analytics system to provide previously unavailable insight into future behavior by the audience related to registration for the event.

### BRIEF DESCRIPTION OF THE DRAWINGS

FIG. 1A depicts an example configuration of an operating environment in which some implementations of the present disclosure can be employed, in accordance with various embodiments.

FIG. 1B depicts an example configuration of another operating environment in which some implementations of the present disclosure can be employed, in accordance with various embodiments.

FIG. 2 depicts an example configuration of an operating environment in which some implementations of the present disclosure can be employed, in accordance with various embodiments.

FIG. 3 provides a process flow showing an embodiment of a method for generating predicted event outcomes, in accordance with embodiments of the present disclosure.

FIG. 4 provides a process flow showing an embodiment for generating predicted event outcomes, in accordance with embodiments of the present disclosure.

FIG. 5 provides a process flow showing an embodiment for generating predicted event outcome for an event, in accordance with embodiments of the present disclosure.

FIG. 6 provides a process flow showing an embodiment for generating predicted event outcome for an event for an audience and a supplemental audience, in accordance with embodiments of the present disclosure.

FIG. 7 depicts an illustrative expected registration profiles for events, in accordance with various embodiments of the present disclosure.

FIG. 8 depicts an illustrative graphical user interface of an attendance optimization system, in accordance with various embodiments.

FIG. 9 is a block diagram of an example computing device in which embodiments of the present disclosure may be employed.

### DETAILED DESCRIPTION

Various terms and phrases are used herein to describe embodiments of the present invention. Some of the terms and phrases used herein are described here, but more details are included throughout the description.

As used herein, the term “event” refers to any type of planned occasion attended by people. For instance, in-person events, executive roundtables, trade shows, webinars, etc. An event can have associated event information that comprises data about an event. For instance, event data can include event features such as event type, event size, event time, event time zone, event location, event tags, etc. Event data can also include time-based registration information. Time-based registration information can be information related to registration by an audience(s) over time (e.g., week, day, hour, etc.) after an invitation to an event was sent to the audience(s). Such event data for an event can be stored using an event profile. For instance, an event profile can include information about an event (e.g., event features, attendance goal, expected registration profile, real-time predicted event outcome, etc.).

The term “user” is used herein to refer to a marketer, publisher, editor, author, or other person who employs the analytics tools described herein to view analyzed audience behavior and generated predicted event outcomes for an event. A user can designate important metrics to use in analyzing the audience behavior. For instance, a user can designate an attendance goal for an event.

The term “audience” is used herein to refer to a set of invitees (e.g., people) that receive invitations to register for an event. Audience behavior can be either predicted audience behavior or real-time audience behavior. Predicted audience behavior can be a number of the set of invitees that are predicted to register for the event (e.g., in the time remaining until the event). Real-time audience behavior can be real-time registration for the event by the set of invitees at a point in time. An attendance goal can be a predefined number of invitees that are desired to register for a particular event. The attendance goal can be input, for example, by a user.

The term “expected registration profile” is used herein to refer to a profile generated and/or augmented from analyzed event data. An expected registration profile can provide insight into predicted audience behavior for an event. In particular, this expected registration profile can provide an indication of predicted audience behavior (e.g., a predicted pattern of registrations over time) for the event. For instance, the expected registration profile can comprise a predicted audience behavior histogram and/or a corresponding time-dependent adjustment function. This predicted audience behavior histogram can represent a historical pattern of registration (e.g., based on event data from one or more corresponding events related to an event being analyzed). Such a predicted audience behavior histogram can be used to determine a corresponding time-dependent adjustment function. The corresponding time-dependent adjustment function can indicate a fraction of expected invitees of the audience that are expected to register at certain points in time (e.g., based on the predicted audience behavior histogram).

The term “predicted event outcome” is used herein to refer to a predicted success of an event. For instance, this predicted success can be based on meeting an attendance goal set for the event. A predicted event outcome can indicate a time-based conversion propensity related to the audience of the event. Such a predicted event outcome can also identify a likelihood of meeting an attendance goal set for the event. This likelihood can be based on the predicted audience behavior indicating registration to the event by the audience. The predicted event outcome can be updated in real-time based on real-time audience behavior.

A vast amount of data can be gathered that relates to events (e.g., attendance numbers, registration of invitees, event features, etc.). Such data can relate to event characteristics and behaviors of individuals invited to attend the events (e.g., registration). Analytics systems are typically employed to process the vast amount of data to assist in decision-making (e.g., targeted marketing campaigns, sending invitations for an event). Often, analytic systems attempt to target individuals to invite to an event that are likely to register and attend the event. However, determining how many of these invited individuals plans to attend the event remains problematic. Existing analytics systems use a wait-and-see approach to attempt to understand how many individuals are likely to attend the event. This approach often fails to proactively predict how many individuals are likely to attend the event until it is too late to efficiently target additional prospects, resulting in a waste of resources.

Accordingly, embodiments of the present disclosure are directed to an improved analytics system (referred to herein as an attendance optimization system) that addresses the technical deficiencies of existing analytics systems with respect to generating and providing accurate real-time registration assessment related to an event. In particular, and as described herein, the attendance optimization system generates predicted event outcomes by leveraging real-time audience behavior for an event. A predicted event outcome can refer to a real-time conversion propensity related to an audience associated with an event (e.g., the audience that has received invitations to register for the event). Advantageously, such a predicted event outcome continuously updates in real-time based on current audience behavior to adjust a predicted registration over time.

Such an attendance optimization system can provide insight into audience behavior related to an event. In particular, predicted audience behavior related to the event can be modified based on the actual registration behavior of an audience. For instance, the attendance optimization system can analyze the real-time conversion of a set of invitees that have been invited to attend an event to determine and/or adjust the overall predicted audience behavior for an event. In this way, the attendance optimization system can identify whether the set of invitees are likely to meet an attendance goal set for the event (e.g., based on the predicted audience behavior combined with the real-time audience behavior indicating an overall registration to the event by the set of invitees).

As described herein, the attendance optimization system analyzes audience behavior related to events to provide predicted event outcomes related to an event. At a high-level, to analyze audience behavior related to events, the attendance optimization system leverages data related to events to predict audience behavior related to an event. In analyzing the audience behavior related to events, event features specific to events can be identified and used to generate an expected registration profile. Combining predicted audience behavior identified using this expected registration profile with real-time audience behavior can then be used to provide previously unavailable insight into future audience behavior related to registration for the event. For instance, when this expected registration profile is applied along with real-time conversion of a set of invitees, a predicted event outcome can be generated that is indicative of a likelihood that an attendance goal set for the event will be met.

In more detail, event information of an event can be analyzed to identify corresponding events. In some embodiments, such corresponding events can be identified by comparing event features from the event with event features of one or more events that has already occurred. Event features can include event type, event size, event time, event time zone, event location, information about the event (e.g., tags associated with the event), etc. In other embodiments, corresponding events can be any type of event that has previously occurred for which registration information is available. Upon identifying corresponding events, event data related to the events can be analyzed. In particular, event data can include time-based registration information related to registration by an audience(s) over time (e.g., week, day, hour) after an invitation to an event was sent to the audience(s).

Analyzing the event data (e.g., corresponding to related events) can provide insight into predicted audience behavior for the event. For instance, analyzed event data can be used to generate an expected registration profile. This expected registration profile can provide an indication of predicted audience behavior (e.g., a predicted pattern of registrations over time) for the event. In particular, the expected registration profile can comprise a predicted audience behavior histogram and/or a corresponding time-dependent adjustment function. This predicted audience behavior histogram can represent a historical pattern of registration (e.g., based on the event data).

For instance, one predicted audience behavior histogram can indicate that roughly 20% of registrations for an event (e.g., that is 28 days away) are expected to happen on or before the 5^{th} day after an invitation to the event is sent, around 50% of registrations for the event are expected to happen on or before the 10^{th} day after the invitation is sent, and over 90% of registrations for an event are expected to happen on or before the 25^{th} day after an invitation to the event is sent. As another example, another predicted audience behavior histogram can indicate that roughly 5% of registrations for an event (e.g., that is 28 days away) are expected to happen on or before the 5^{th} day after an invitation to the event is sent, around 20% of registrations for the event are expected to happen on or before the 10^{th} day after the invitation is sent, and over 90% of registrations for an event are expected to happen on or before the 25^{th} day after an invitation to the event is sent.

Such a predicted audience behavior histogram can be used to determine a corresponding time-dependent adjustment function. The corresponding time-dependent adjustment function can indicate a fraction of expected invitees of the audience that are expected to register at certain points in time (e.g., based on the predicted audience behavior histogram).

For instance, using the first example above, the time-dependent adjustment function on the 5^{th} day would be around 0.8 (e.g., indicating roughly 20% of registrations are predicted), the time-dependent adjustment function on the 10^{th} day would be around 0.5 (e.g., indicating roughly 50% of registrations are predicted), and the time-dependent adjustment function on the 25^{th} day would be less than 0.1 (e.g., indicating roughly 90% of registrations are predicted). Using the second example above, on the other hand, the time-dependent adjustment function on the 5^{th} day would be around 0.95 (e.g., indicating roughly 5% of registrations are predicted), the time-dependent adjustment function on the 10^{th} day would be around 0.8 (e.g., indicating roughly 20% of registrations are predicted), and the time-dependent adjustment function on the 25^{th} day would be less than 0.1 (e.g., indicating roughly 90% of registrations are predicted).

The expected registration profile can be used to analyze real-time audience behavior leading up to the event. In particular, real-time audience behavior can be analyzed using the expected registration profile to generate a predicted event outcome. The predicted event outcome can indicate a time-based conversion propensity related to the audience of the event. In this way, the predicted audience behavior can be combined with real-time audience behavior to provide insight into future audience behavior. For example, the predicted event outcome can identify a likelihood as to whether the audience is likely to meet an attendance goal set for the event. This likelihood can be based on the predicted audience behavior indicating registration to the event by the audience. Over time, as registrations are received for the event, the predicted event outcome can be updated (e.g., in real-time) based on the expected registration profile. As such, continuous updates can be made in real-time to the predicted event outcome based on current audience behavior (e.g., based on a continually updated predicted registration over time).

As an illustrative example based on the first example above, if the event audience is comprised of 500 invitees with the attendance goal of 450 invitees attending; and on the 5^{th} day 130 invitees have registered for the event—the predicted event outcome can indicate a high likelihood of meeting the attendance goal. In particular, in the first example above, by the 5^{th} day roughly 20% of registrations were predicted; if 130 registrations are received by the 5^{th} day, using an expected registration profile, the time-dependent adjustment function (e.g., 0.8) indicates what number of the remaining 370 invitees are likely to register for the event in the time remaining until the event occurs (e.g., based on each invitee's likelihood of registration predicted at the time of invitation). This number can be combined with the real-time audience behavior (e.g., actual registration) to indicate a number of likely registrations (e.g., predicted registrations plus actual registrations). When the predicted event outcome of registrations is greater than the attendance goal of 450, this indicates a high likelihood of meeting the attendance goal. On the other hand, only receiving 50 registrations by the 5^{th} day (e.g., less than the expected 20% of predicted registrations), can result in an indication that there is a likelihood that the attendance goal will not be met. This predicted event outcome provides insight into whether additional invitees should be invited to the event to increase the likelihood of meeting the attendance goal.

In some embodiments, the insight provided by the attendance optimization system can be used in targeting an additional set of invitees when a predicted event outcome for an initial set of invitees fails to meet a predefined threshold (e.g., of the attendance goal set for the event). For instance, the attendance optimization system can accurately predict that an initial set of invitees are not likely meet an attendance goal set of an event and then provide further recommendations (e.g., identifying similar individuals to also invite to the event). Such targeting of an additional set of invitees can be performed using, for example, methods discussed with reference to Application ______, which is incorporated herein by reference.

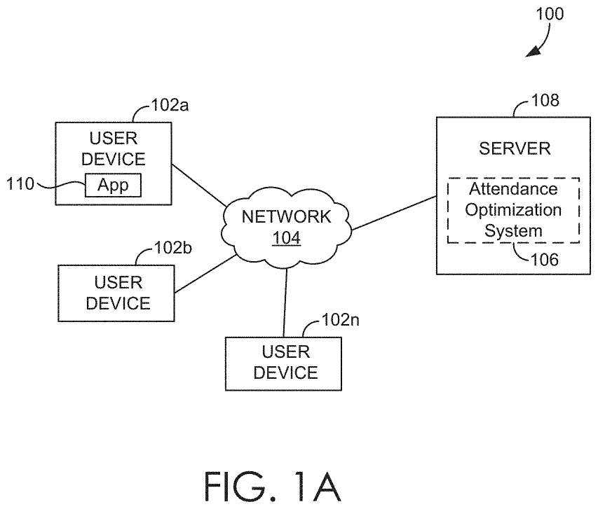

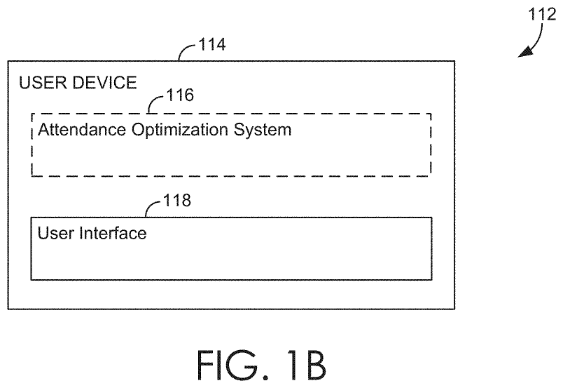

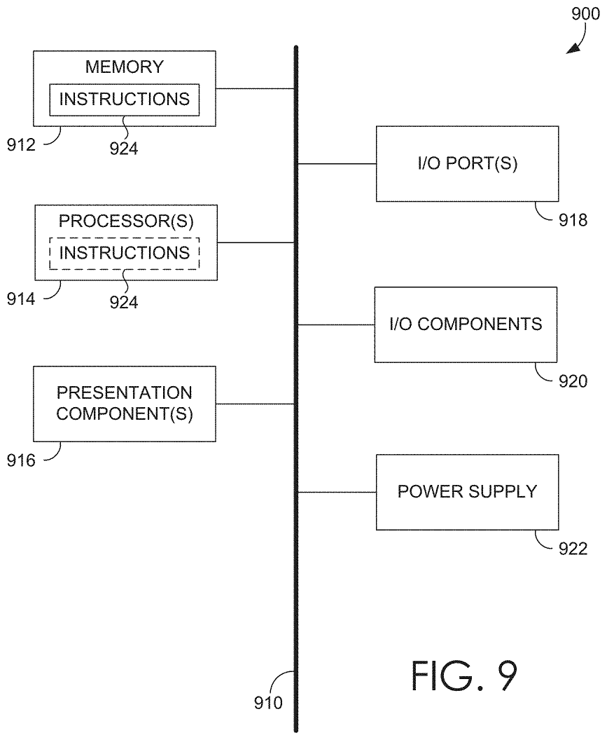

Turning now to FIG. 1A, an example configuration of an operating environment is depicted in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 9.

It should be understood that operating environment 100 shown in FIG. 1A is an example of one suitable operating environment. Among other components not shown, operating environment 100 includes a number of user devices, such as user devices 102a and 102b through 102n, network 104, and server(s) 108. Each of the components shown in FIG. 1A may be implemented via any type of computing device, such as one or more of computing device 900 described in connection to FIG. 9, for example. These components may communicate with each other via network 104, which may be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 104 is not described in significant detail.

It should be understood that any number of user devices, servers, and other components may be employed within operating environment 100 within the scope of the present disclosure. Each may comprise a single device or multiple devices cooperating in a distributed environment.

User devices 102a through 102n can be any type of computing device capable of being operated by a user. For example, in some implementations, user devices 102a through 102n are the type of computing device described in relation to FIG. 9. By way of example and not limitation, a user device may be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user devices can include one or more processors, and one or more computer-readable media. The computer-readable media may include computer-readable instructions executable by the one or more processors. The instructions may be embodied by one or more applications, such as application 110 shown in FIG. 1A. Application 110 is referred to as a single application for simplicity, but its functionality can be embodied by one or more applications in practice. As indicated above, the other user devices can include one or more applications similar to application 110.

The application(s) may generally be any application capable of facilitating the exchange of information between the user devices and the server(s) 108 for predicting event outcomes. This predicted event outcome can provide insight into audience behavior related to an event. For instance, the predicted event outcome can identify a likelihood as to whether an event audience is likely to meet an attendance goal set for the event. Such a predicted event outcome can be based on a predicted audience behavior related to the event that is modified based on the actual registration behavior of an audience of the event. In some implementations, the application(s) comprises a web application, which can run in a web browser, and could be hosted at least partially on the server-side of environment 100. In addition, or instead, the application(s) can comprise a dedicated application, such as an application having attendance optimization functionality. In some cases, the application is integrated into the operating system (e.g., as a service). It is therefore contemplated herein that “application” be interpreted broadly.

In accordance with embodiments herein, the application 110 facilitates predicting event outcomes. In particular, predicting an event outcome based on a predicted audience behavior related to an event along with real-time audience behavior related to the event. In embodiments, an event can be selected, for instance, by a user of application 110. A “user” can be a marketer, publisher, editor, author, or other person who employs the attendance optimization system to analyze events and view predicted event outcomes based on predicted audience behavior related to the event that is modified based on the actual registration behavior of an audience of the event. A user can designate an attendance goal for an event. Based on an audience invited to the event, an expected registration profile can be generated for the event that provides an indication of predicted audience behavior for the event. Such an expected registration profile can be based on a predicted pattern of registrations over time for the event. This expected registration profile used to analyze real-time audience behavior leading up to the event. In particular, the expected registration profile can be used to analyze the predicted audience behavior in light of real-time audience behavior.

The expected registration profile can be based on a predicted pattern of audience registrations over time for the event. In embodiments, the expected registration profile can comprise a predicted audience behavior histogram and/or a corresponding time-dependent adjustment function. Such an expected registration profile can be generated for a specific event (e.g., using event data of corresponding events). For instance, corresponding events can be identified using event features that include event type, event size, event time, event time zone, event location, information about the event. Registration information from such corresponding events can be used to generate the predicted audience behavior histogram and/or a corresponding time-dependent adjustment function. Such an expected registration profile can also be generic, using event data from events that have previously occurred for which registration information is available.

The expected registration profile can be added to an event profile. The event profile can include information about an event (e.g., target audience, attendance goal, event features, etc.). The predicted event outcome for an event can be output to a user, for example, via the user device 102a. Such output can be used to provide insight into a predicted success of an event (e.g., based on meeting an attendance goal). As an example, application 110 can be an application associated with ADOBE EXPERIENCE CLOUD—MARKETO.

As described herein, server 108 facilitates predicting event outcomes via attendance optimization system 106. Server 108 includes one or more processors, and one or more computer-readable media. The computer-readable media includes computer-readable instructions executable by the one or more processors. The instructions may optionally implement one or more components of attendance optimization system 106, described in additional detail below.

Attendance optimization system 106 can generate a predicted event outcome for an event. The system can employ data related to previous events. For instance, a events can have associated data such as event features and time-based registration information Such event features can include event type, event size, event time, event time zone, event location, information about the event. Such time-based registration information can be information related to event registration over the time after invitations to the event were sent out to an audience.

For cloud-based implementations, the instructions on server 108 may implement one or more components of attendance optimization system 106, and application 110 may be utilized by a user to interface with the functionality implemented on server(s) 108. In some cases, application 110 comprises a web browser. In other cases, server 108 may not be required, as further discussed with reference to FIG. 1B. For example, the components of prod attendance optimization system 106 may be implemented completely on a user device, such as user device 102a. In this case, attendance optimization system 106 may be embodied at least partially by the instructions corresponding to application 110.

Referring to FIG. 1B, aspects of an illustrative attendance optimization system are shown, in accordance with various embodiments of the present disclosure. FIG. 1B depicts a user device 114, in accordance with an example embodiment, configured to allow for attendance optimization system 116 to generate a predicted event outcome based on predicted audience behavior related to an event along with real-time audience behavior related to the event. The user device 114 may be the same or similar to the user device 102a-102n and may be configured to support the attendance optimization system 116 (as a standalone or networked device). For example, the user device 114 may store and execute software/instructions to facilitate interactions between a user and the attendance optimization system 116 via the user interface 118 of the user device.

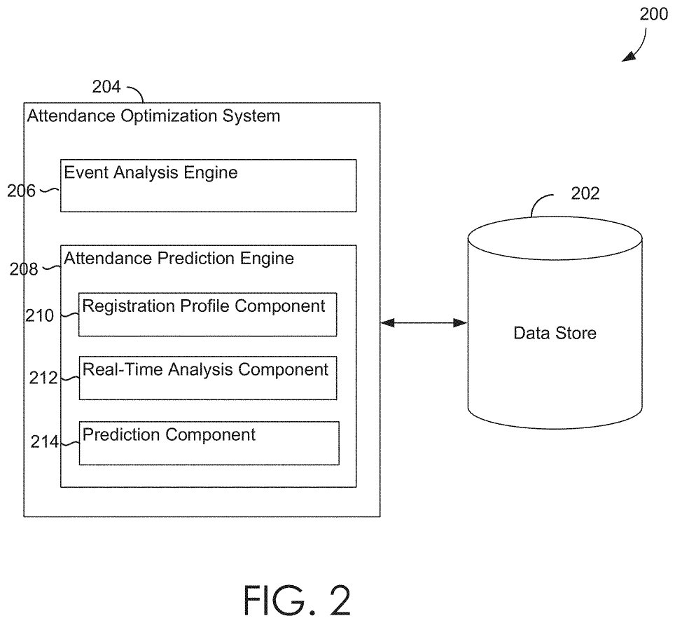

FIG. 2 depicts an example configuration of an operating environment in which some implementations of the present disclosure can be employed, in accordance with various embodiments. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory as further described with reference to FIG. 9. It should be understood that operating environment 200 shown in FIG. 2 is an example of one suitable operating environment. Among other components not shown, operating environment 200 includes a number of user devices, networks, and server(s).

As depicted, attendance optimization system 204 includes event analysis engine 206 and attendance prediction engine 208. The foregoing engines of attendance optimization system 204 can be implemented, for example, in operating environment 100 of FIG. 1A and/or operating environment 112 of FIG. 1B. In particular, those engines may be integrated into any suitable combination of user devices 102a and 102b through 102n and server(s) 106 and/or user device 114. While the various engines are depicted as separate engines, it should be appreciated that a single engine can perform the functionality of all engines. Additionally, in implementations, the functionality of the engines can be performed using additional engines and/or components. Further, it should be appreciated that the functionality of the engines can be provided by a system separate from the attendance optimization system.

As shown, attendance optimization system 204 operates in conjunction with data store 202. Data store 202 stores computer instructions (e.g., software program instructions, routines, or services), data, and/or models used in embodiments described herein. In some implementations, data store 202 stores information or data received via the various engines and/or components of attendance optimization system 204 and provide the engines and/or components with access to that information or data, as needed. Although depicted as a single component, data store 202 may be embodied as one or more data stores. Further, the information in data store 202 may be distributed in any suitable manner across one or more data stores for storage (which may be hosted externally).

In embodiments, data stored in data store 202 includes event data. Event data generally refers to data related to events (e.g., a roundtable, a video conference, a trade show). Event data can include information related to event features and time-based registration information. Such event features can include event type, event size, event time, event time zone, event location, information about the event. Such time-based registration information can be information related to event registration over the time after invitations to the event were sent out to an audience.

Further data stored in data store 202 can include event profiles. An event profile can include information about an event (e.g., event features, attendance goal, expected registration profile, real-time predicted event outcome, etc.). As discussed above, event features can include event type, event size, event time, event time zone, event location, information about the event (e.g., tags associated with the event), etc. An attendance goal can be a predefined number of invitees that are desired to attend a particular event. The attendance goal can be input, for example, by a user. The expected registration profile can provide an indication of predicted audience behavior (e.g., a predicted pattern of registrations over time) for the event. In some embodiments, the expected registration profile can comprise a predicted audience behavior histogram and/or a corresponding time-dependent adjustment function. The real-time predicted event outcome can be generated using predicted audience behavior related to an event along with real-time audience behavior to provide insight into further audience behavior.

Attendance optimization system 204 can generate a predicted event outcome that can be used for better understanding a likelihood of meeting an attendance goal set for an event. To generate the predicted event outcome, such a system can leverage data of an event to identify an expected registration profile. This expected registration profile can provide an indication of predicted audience behavior (e.g., a predicted pattern of registrations over time) for the event. The expected registration profile can be used to generate the predicted event outcome based on real-time audience behavior. Upon predicting an event outcome, a likelihood of meeting an attendance goal set for an event can be determined. This likelihood can provide insight into predicted success of an event (e.g., based on meeting an attendance goal). Such predicted event outcome can be used in targeting additional invitees to an event when a predicted event outcome for an initial set of invitees fails to meet a predefined threshold (e.g., indicates the attendance goal will not be met for the event). In particular, the attendance optimization system 204 can identify potential additional invitees that should be invited to the event to help meet the attendance goal.

Event analysis engine 206 can obtain data related to events. Event data can be received from a data store based on identified corresponding events. In an embodiment, the event data can be retrieved from data store 202. In other embodiments, the event data can be retrieved from a server that stores event information. Event data can generally refer to data associated with one or more events. In embodiments, such event data can include event features and time-based registration information. For instance, event features can include event type, event size, event time, event time zone, event location, associated tags, etc. Time-based registration information can indicate how invitees registered for the event, (e.g., based on a time of registration within a timeframe from receiving an invite to the event occurring). As an example, an event (e.g., a patent attorney conference) can have associated event features (e.g., event size: 50-75, event time: lunch, event time zone: Pacific Time, event location: law firm, etc.). In some embodiments, corresponding events can be identified by comparing event features from the event with event features of one or more events that has already occurred. In other embodiments, corresponding events can be any type of event that has previously occurred for which registration information is available.

In some embodiments, event analysis engine 206 can identify corresponding events for an event. In some embodiments, corresponding events can be identified by comparing event features from the event with event features of one or more events that has already occurred. In other embodiments, corresponding events can be any type of event that has previously occurred for which registration information is available. Identified corresponding events can be limited to within a relevant timeframe (e.g., past 6 months). Limiting the timeframe can increase accuracy of the information related to the corresponding events. In some embodiments, this comparison can be used to identify related event data from corresponding events that are statistically similar to the event. Statistical similarity can be based on a similarity score determined by comparing the event features. In such an embodiment, a top number of events (e.g., top 5, 10, 20, 200 events) can be selected based on the similarity score (e.g., events with 90% similar event features). Based on identified related event data, time-based registration information can be identified (e.g., for the one or more events that has already occurred that correspond to the related event data).

Attendance prediction engine 208 can generate predicted event outcomes by leveraging real-time audience behavior for an event. In particular, an expected registration profile can be generated for an event. The expected registration profile provides an indication of predicted audience behavior for the event (e.g., based on how audiences behaved when registering for corresponding events with features related to the event). The expected registration profile can be used to perform a real-time analysis of audience behavior leading up to the event. In particular, real-time audience behavior can be analyzed using the expected registration profile to generate a predicted event outcome

As depicted, attendance prediction engine 208 includes registration profile component 210, adjustment component 212, and prediction component 214. The foregoing components of attendance prediction engine 208 can be implemented, for example, in operating environment 100 of FIG. 1A and/or operating environment 112 of FIG. 1B. In particular, these components may be integrated into any suitable combination of user devices 102a and 102b through 102n and server(s) 106 and/or user device 114. While the various components are depicted as separate components, it should be appreciated that a single component can perform the functionality of all components. Additionally, in implementations, the functionality of the components can be performed using additional components and/or engines. Further, it should be appreciated that the functionality of the components can be provided by an engine separate from the attendance prediction engine.

Registration profile component 210 can generate an expected registration profile based on analyzing audience behavior related to the events to correspond to the event. Such an expected registration profile can be based on a predicted pattern of registrations over time for the event. In particular, the expected registration profile can be used to analyze the predicted audience behavior in light of real-time audience behavior. Such an expected registration profile can be generated for a specific event (e.g., using event data of corresponding events). For instance, corresponding events can be identified using event features that include event type, event size, event time, event time zone, event location, information about the event (e.g., event data identified using event analysis engine 206). Such an expected registration profile can also be generic, using event data from events that have previously occurred for which registration information is available. In embodiments, the expected registration profile can comprise a predicted audience behavior histogram and/or a corresponding time-dependent adjustment function.

Registration information from such corresponding events can be used to generate the expected registration profile. In particular, event data such as time-based registration information (e.g., identified using event analysis engine 206) can be analyzed to generate the expected registration profile. The expected registration profile provides an indication of predicted audience behavior for the event (e.g., based on how audiences behaved when registering for corresponding events with features related to the event). In embodiments, the expected registration profile can be a predicted audience behavior histogram and/or a corresponding time-dependent adjustment function. A predicted audience behavior histogram can represent a historical pattern of registration (e.g., based on identified event data). Such a predicted audience behavior histogram can be used to determine a corresponding time-dependent adjustment function. The corresponding time-dependent adjustment function can indicate a fraction of expected invitees of the audience that are expected to register at certain points in time (e.g., based on the predicted audience behavior histogram).

Various techniques can be employed to generate the expected registration profile. In some embodiments, expected registration profile can be generated using time-based registration information from a top number of events identified based on related event data. In particular, the time-based registration information from the top number of events can be used to generate the predicted audience behavior histogram. From this predicted audience behavior histogram, the corresponding time-dependent adjustment function can be determined. In other embodiments, the expected registration profile can be generated using quantile regression. For instance, quantile regression can be used to regress a registration rate from events that have already occurred that is based on the event features. In this way, quantile regression can allow a predicted audience behavior histogram to be generated that indicated the distribution of registration over time based on event features. Further techniques utilized can be a machine learning processes. Machine learning processes can, in some embodiments, be employed to generate a predicted audience behavior histogram based on a set of events selected by a machine learning model. In particular, a machine learning model can analyze event features for an event in comparison to event features from one or more events that have already occurred to identify which of the one or more event should be selected to build the predicted audience behavior histogram.

Real-time analysis component 212 can use an expected registration profile related to an event to analyze real-time audience behavior leading up to the event. In particular, the expected registration profile can be applied at a particular time (e.g., a time point in the timeframe between invitations to the event being sent and the occurrence of the event) along with real-time audience behavior. This combination can provide previously unavailable insight into future audience behavior related to registration for the event. In particular, based on the time point being analyzed, the expected registration profile can provide a time-based prediction for the number of invitees that are likely to register from that time point until the event. More specifically, this time-based prediction can indicate the impact of the predicted pattern of registrations over time for the event on the remaining invitees that have not yet registered for the event. For instance, if there are 50 invitees that have not yet registered for the event, and there are 10 days left until an event occurs, the time-based prediction can indicate what number of those 50 invitees are likely to register for the event in the upcoming 10 days based on the predicted pattern of registrations over those upcoming 10 days. This number of invitees that are likely to register from that time point until the event can be combined with the real-time audience behavior (e.g., number of actual invitee registrations that have been received by the time point). This combination can then be analyzed using, for example, prediction component 214, to provide a predicted event outcome for an event.

Prediction component 214 compiles the various analysis and results determined by real-time analysis component 212 into a predicted event outcome for an event. The predicted event outcome can indicate a time-based conversion propensity related to the audience of the event. Such a predicted event outcome can also identify a likelihood of meeting an attendance goal set for the event. This likelihood can be based on the predicted audience behavior indicating registration to the event by the audience. The predicted event outcome can be updated in real-time based on real-time audience behavior. In some embodiments, the predicted event outcome can be updated at predefined time intervals. In other embodiments, the predicted event outcome can be updated each time an invitee registers for the event. In further embodiments, the predicted event outcome can be updated each time a user views an event profile related to the event. Such a predicted event outcome can be integrated into an event profile. An event profile can include can include information about an event (e.g., target audience, attendance goal, event features, etc.).

Over time, as registrations are received for the event, prediction component 214 can update (e.g., in real-time) the predicted event outcome based on the expected registration profile and real-time analysis of audience behavior. As such, continuous updates can be made in real-time to the predicted event outcome based on current audience behavior (e.g., based on a continually updated predicted registration over time).

Prediction component 214 can also provide information that can be leveraged for additional targeting of individuals to invite to the event. For instance, the predicted event outcome can be used in targeting an additional set of invitees when a predicted event outcome for an initial set of invitees fails to meet a predefined threshold (e.g., of the attendance goal set for the event). For instance, the attendance optimization system can accurately predict that an initial set of invitees are not likely meet an attendance goal set of an event and then provide further recommendations (e.g., identifying similar individuals to also invite to the event).

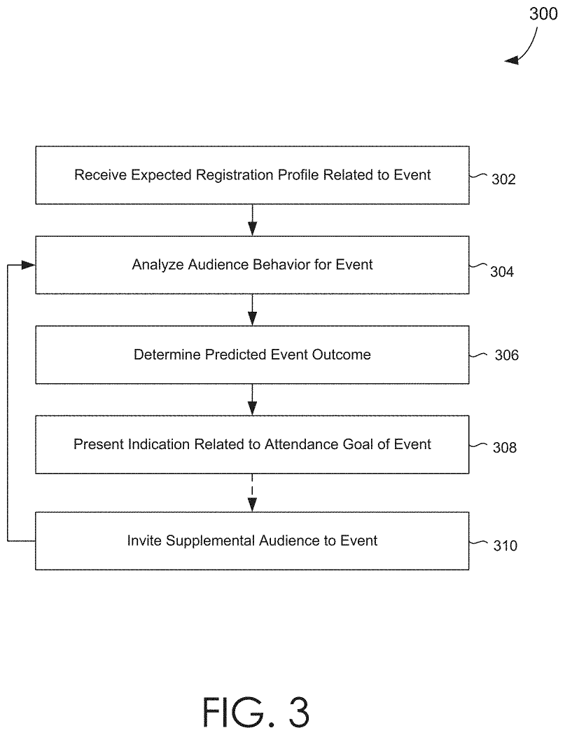

Turning now to FIG. 3, a process flow shows an embodiment of method 300 for generating predicted event outcomes, in accordance with embodiments of the present disclosure. Method 300 can be performed, for example by attendance optimization system 204, as illustrated in FIG. 2.

At block 302, an expected registration profile related to an event can be received. Such an expected registration profile can be generated for a specific event (e.g., using event data of corresponding events). Such an expected registration profile can also be generic, using event data from events that have previously occurred for which registration information is available. An expected registration profile can be generated using registration profile component 210 of attendance prediction engine 208 as discussed with reference to FIG. 2.

At block 304, audience behavior for an event can be analyzed. An event to analyze can be selected, for instance, by a user. A “user” can be a marketer, publisher, editor, author, or other person who employs the analytics tools described herein to view analyzed audience behavior and generated predicted event outcome for events. Audience behavior can be analyzed using, for example, an expected registration profile. For instance, the expected registration profile can be applied at a particular point in time (e.g., a time point in the timeframe between invitations to the event being sent and the occurrence of the event). In particular, based on the time point being analyzed, the expected registration profile can provide a time-based prediction for a number of invitees that are likely to register in the time remaining from that time point until the event. This number of invitees that are likely to register in the time remaining until the event occurs can be combined with the real-time audience behavior (e.g., number of actual invitee registrations that have been received by the time point). This combination can then be analyzed to provide a predicted event outcome for an event.

At block 306, a predicted event outcome can be determined. The predicted event outcome can indicate a time-based conversion propensity related to the audience of the event. Such a predicted event outcome can also identify a likelihood of meeting an attendance goal set for the event. This likelihood can be based on the predicted audience behavior indicating registration to the event by the audience. The predicted event outcome can be updated in real-time based on real-time audience behavior. In some embodiments, the predicted event outcome can be updated at predefined time intervals. In other embodiments, the predicted event outcome can be updated each time an invitee registers for the event. In further embodiments, the predicted event outcome can be updated each time a user views an event profile related to the event.

At block 308 an indication related to an attendance goal for the event can be presented. This indication can be a predicted number of invitees that will register for the event. This indication can also be a likelihood of meeting an attendance goal set for the event. In some embodiments, such a likelihood of meeting an attendance goal set for the event can be indicated using a color. For example, displaying the predicted number of invitees using green can indicate that the current prediction indicates the attendance goal for the event will be met. Displaying the predicted number of invitees using red can indicate that the current prediction indicates the attendance goal for the event will not be met. Such a predicted event outcome can be integrated into and displayed using an event profile.

In instances when the method progresses to block 310, a supplemental audience can be invited to the event. In particular, an additional set of invitees can be targeted when a predicted event outcome for an initial set of invitees fails to meet a predefined threshold (e.g., of the attendance goal set for the event). For instance, the attendance optimization system can accurately predict that an initial set of invitees are not likely meet an attendance goal set of an event and then provide further recommendations (e.g., identifying similar individuals to also invite to the event). When a supplemental audience is invited to the event, an updated expected registration profile can be generated. This updated expected registration profile can indicate an updated predicted audience behavior for the event based on a combination of the predicted audience behavior for the original audience and an additional predicted audience behavior for the supplemental audience.

Blocks 304 to 310 can be repeated for additional customers identified as individuals who purchased the selected product. The process can be repeated for any number of iterations or until all customers identified as purchasing the selected product are analyzed.

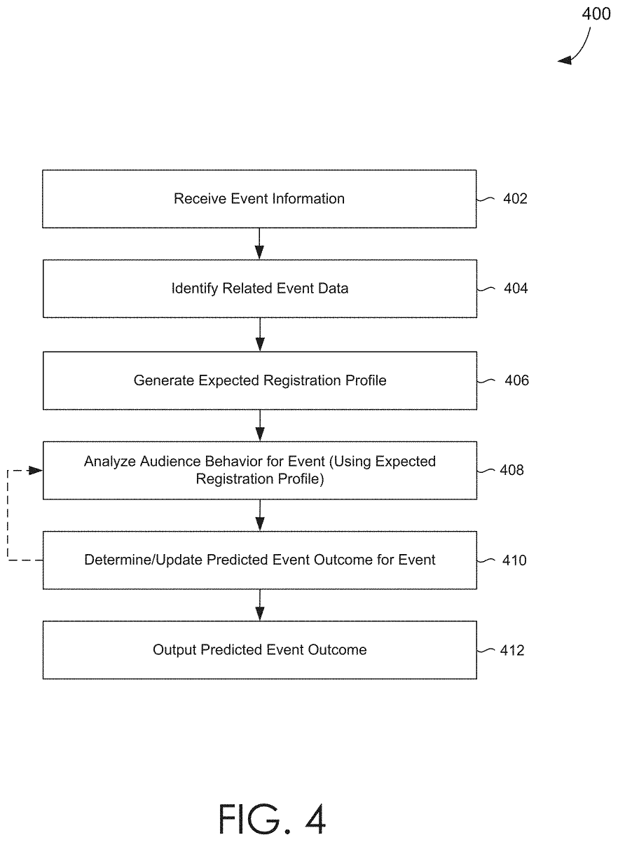

Turning now to FIG. 4, a process flow shows an embodiment of method 400 for generating predicted event outcomes, in accordance with embodiments of the present disclosure. Method 400 can be performed, for example by attendance optimization system 204, as illustrated in FIG. 2.

At block 402, event information can be received. Such event information can be an event profile that comprises data about an event. For instance, event data can include event features such as event type, event size, event time, event time zone, event location, event tags, etc. This event information can be used to identify related event data at block 404.

In particular, at block 404, event data of the event can be compared with event data with one or more events that has already occurred to identify related event data. This comparison can be based on comparing event features for the event with event features from the one or more events. In some embodiments, this comparison can be used to identify related event data from corresponding events within a relevant time frame (e.g., past 6 months) that are statistically similar to the event. Statistical similarity can be based on a similarity score determined by comparing the event features. In such an embodiment, a top number of events (e.g., top 5, 10, 20, 200 events) can be selected based on the similarity score (e.g., events with 90% similar event features). In other embodiments, related event data can be from any event that has previously occurred for which registration information is available. Based on identified related event data, time-based registration information can be identified (e.g., for the one or more events that has already occurred that correspond to the related event data).

At block 406, an expected registration profile can be generated. An expected registration profile can provide an indication of predicted audience behavior (e.g., a predicted pattern of registrations over time) for the event. To generate an expected registration profile for the event, time-based registration information can be used from one or more events that has already occurred. Such events can be the one or more events that correspond to the related event data identified at block 404. This expected registration profile can comprise a predicted audience behavior histogram and/or a corresponding time-dependent adjustment function.

Various techniques can be employed to generate the expected registration profile. One technique utilized can be using time-based registration information from a top number of events identified based on related event data. In particular, the time-based registration information from the top number of events can be used to generate a predicted audience behavior histogram. This predicted audience behavior histogram can represent a historical pattern of registration based on the event data from the top number of events. From this predicted audience behavior histogram, a corresponding time-dependent adjustment function can be determined. In particular, the corresponding time-dependent adjustment function can indicate a fraction of expected invitees of an audience invited to the event that are expected to register at certain points in time (e.g., based on the predicted audience behavior histogram).

Another technique utilized can be quantile regression. For instance, quantile regression can be used to regress a registration rate of events that have already occurred that is based on the event features. In this way, quantile regression can allow a predicted audience behavior histogram to be generated that indicated the distribution of registration over time based on event features.

Further techniques utilized can be a machine learning processes. Machine learning processes can, in some embodiments, be employed to generate a predicted audience behavior histogram based on a set of events selected by a machine learning model. In particular, a machine learning model can analyze event features for an event in comparison to event features from one or more events that have already occurred to identify which of the one or more event should be selected to build the predicted audience behavior histogram.

At block 408, audience behavior can be analyzed for an event. In particular, the expected registration profile can be used to analyze real-time audience behavior in the time leading up to the event (e.g., after invitations to the event are sent out to an audience). For instance, the expected registration profile can be applied at a particular point in time to determine a time-based prediction for a number of invitees that are likely to register in the time remaining until the event. This number of invitees that are likely to register in the time remaining until the event occurs can be combined with the real-time audience behavior (e.g., number of actual invitee registrations that have been received by the time point). This combination can then be analyzed to provide a predicted event outcome for an event.

At block 410, a predicted event outcome can be determined and/or updated for the event. The predicted event outcome can indicate a time-based conversion propensity related to the audience of the event. Such a predicted event outcome can also identify a likelihood of meeting an attendance goal set for the event. This likelihood can be based on the predicted audience behavior combined with the real-time audience behavior. For instance, the predicted event outcome can be updated in real-time based on real-time audience behavior as invitees register for the event.

Blocks 408 to 410 can be repeated as time progresses. For instance, real-time audience behavior can be continually analyzed from the time invitations to the event are sent out until the occurrence of the event. During this time period, the predicted event outcome can be determined and/or updated to reflect real-time audience behavior and its effect on the outcome of the event. In some embodiments, the predicted event outcome can be updated at predefined time intervals. In other embodiments, the predicted event outcome can be updated each time an invitee registers for the event. In further embodiments, the predicted event outcome can be updated each time a user views an event profile related to the event.

At block 412, the predicted event outcome can be output. For instance, an indication of the predicted event outcome can be output to a user. A “user” can be a marketer, publisher, editor, author, or other person who employs the analytics tools described herein to view analyzed audience behavior and generated predicted event outcome for events. In some instances, the indication of the predicted event outcome can be a predicted number of invitees that will register for the event based on the real-time analysis of audience behavior. In further instances, this indication can also be a likelihood of meeting an attendance goal set for the event based on the real-time analysis of audience behavior.

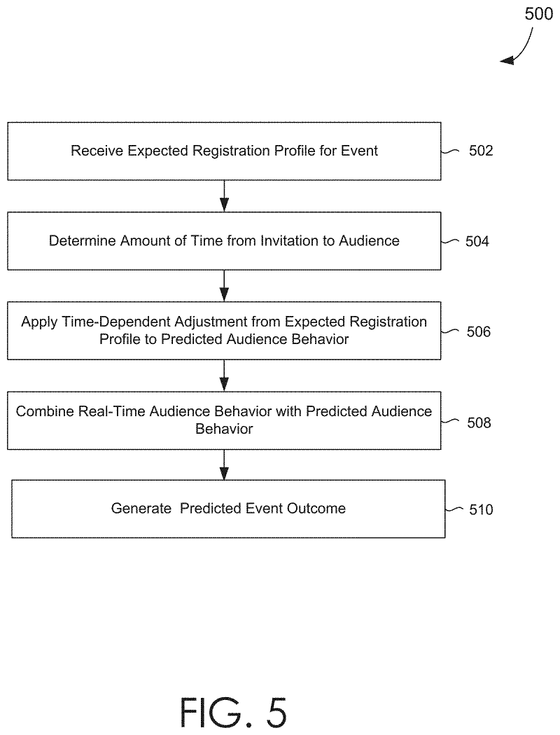

FIG. 5 provides a process flow showing an embodiment of method 500 for generating predicted event outcome for an event, in accordance with embodiments of the present disclosure. Method 500 can be performed, for example by attendance optimization system 204, as illustrated in FIG. 2.

At block 502, an expected registration profile related to an event can be received. Such an expected registration profile can be generated for a specific event (e.g., based on event features of the event). Such an expected registration profile can also be generic, using event data from events that have previously occurred for which registration information is available. An expected registration profile can be generated using the various techniques as discussed with reference to FIGS. 2 and 4 This expected registration profile can comprise a predicted audience behavior histogram and/or a corresponding time-dependent adjustment function.

At block 504, an amount of time can be determined from when invitations to the event were sent out to an audience. In some embodiments, this amount of time can be a number of hours, days, or weeks from when invitations were sent out to the audience. In other embodiments, this amount of time can be a percentage of time that has passed. For instance, a percentage of time that has passed given a total time between invitations being sent and the event occurring. This amount of time can be used to determine what time-dependent adjustment function should be applied to predict audience behavior for the event.

At block 506, a time-dependent adjustment function can be used to predict audience behavior for the event. In particular, a time-dependent adjustment function can be identified using the expected registration profile based on the amount of time that has passed since invitations were sent out to the event (e.g., as determined at block 504). This time-dependent adjustment function can indicate a fraction of expected invitees of an audience invited to the event that are expected to register based on the amount of time that has passed since invitations were sent. This time-dependent adjustment function can be applied to an attendance goal to predict audience behavior moving forward (e.g., a predicted number of invitees from the audience that are likely to register in the time remaining until the event occurs).

At block 508, real-time audience behavior can be combined with predicted audience behavior. In particular, a number of invitees that have registered for the event (e.g., real-time audience behavior) can be combined with a predicted number of invitees from the audience that are likely to register in the time remaining until the event occurs (e.g., predicted audience behavior). This combination can be used to generate a predicted event outcome at block 510. In particular, the predicted event outcome can indicate a time-based conversion propensity related to the audience of the event. Such a predicted event outcome can also identify a likelihood of meeting an attendance goal set for the event. This likelihood can be based on the predicted audience behavior indicating registration to the event by the audience. The predicted event outcome can be updated in real-time based on real-time audience behavior. Such a predicted event outcome can be integrated into an event profile that includes information about an event (e.g., target audience, attendance goal, event features, etc.).

In some embodiments, the insight provided by the predicted event outcome can be used in targeting a supplemental audience. A supplemental audience can be an additional set of invitees that are invited to the event when a predicted event outcome for an initial set of invitees fails to meet a predefined threshold (e.g., of the attendance goal set for the event). For instance, the predicted event outcome can indicate an initial set of invitees are not likely meet an attendance goal set of an event. A user can rely on this information to then send additional invitations out to the supplemental audience such that the attendance goal set of the event is met.

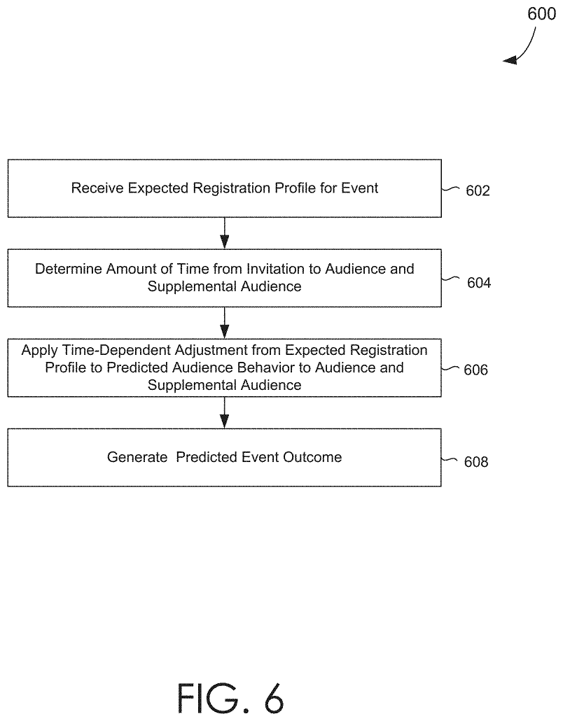

FIG. 6 provides a process flow showing an embodiment of method 600 for generating predicted event outcome for an event for an audience and a supplemental audience, in accordance with embodiments of the present disclosure. Method 600 can be performed, for example, attendance optimization system 204, as illustrated in FIG. 2.

At block 602, an expected registration profile related to an event can be received. Such an expected registration profile can be generated for a specific event (e.g., based on event features of the event). Such an expected registration profile can also be generic, using event data from events that have previously occurred for which registration information is available. An expected registration profile can be generated using the various techniques as discussed with reference to FIGS. 2 and 4. This expected registration profile can comprise a predicted audience behavior histogram and/or a corresponding time-dependent adjustment function.

At block 604, an amount of time can be determined from when invitations to the event were sent out to an audience and to a supplemental audience. In some embodiments, these amounts of time can be a number of hours, days, or weeks from when invitations were sent out to the audience. In other embodiments, these amounts of time can be a percentage of time that has passed. For instance, a percentage of time that has passed given a total time between invitations being sent and the event occurring. These amounts of time can be used to determine what time-dependent adjustment function should be applied to predict audience behavior for the event.

At block 606, a time-dependent adjustment function can be used to predict audience behavior for the event. In particular, a time-dependent adjustment function can be identified for the audience using the expected registration profile based on the amount of time that has passed since invitations were sent out to the audience (e.g., as determined at block 604). A time-dependent adjustment function can also be identified for the supplemental audience using the expected registration profile based on the amount of time that has passed since invitations were sent out to the supplemental audience (e.g., as determined at block 604). These time-dependent adjustment functions can indicate a fraction of expected invitees of the audience and the supplemental audience invited to the event that are expected to register based on the amounts of time that have passed since invitations were sent. These time-dependent adjustment functions can be applied to an attendance goal to predict audience behavior moving forward (e.g., a predicted number of invitees from the audience and a predicted number of invitees from the supplemental audience that are likely to register in the time remaining until the event occurs).

At block 608, a predicted event outcome can be generated for the event. This predicted event outcome can be based on real-time audience behavior of the audience and the supplemental audience combined with predicted audience behavior for the audience and the supplemental audience. For instance, a number of invitees of the audience that have registered for the event (e.g., real-time audience behavior of the audience) can be combined with a predicted number of invitees from the audience that are likely to register in the time remaining until the event occurs (e.g., predicted audience behavior of the audience). Further, a number of invitees of the supplemental audience that have registered for the event (e.g., real-time audience behavior of the supplemental audience) can be combined with a predicted number of invitees from the supplemental audience that are likely to register in the time remaining until the event occurs (e.g., predicted audience behavior of the supplemental audience). These can then be combined to determine a total time-based conversion propensity related to the audience and supplemental audience. Such a predicted event outcome can also identify a likelihood of meeting an attendance goal set for the event. This likelihood can be based on the predicted audience behavior indicating registration to the event by the audience and the supplemental audience. The predicted event outcome can be updated in real-time based on real-time audience behavior of the audience and the supplemental audience. Such a predicted event outcome can be integrated into an event profile that includes information about an event (e.g., target audience, attendance goal, event features, etc.). In embodiments, when the predicted event outcome related to the audience and the supplemental audience still indicates that an attendance goal is not likely to be met for the event, a further supplemental audience can be identified and invited to the event.

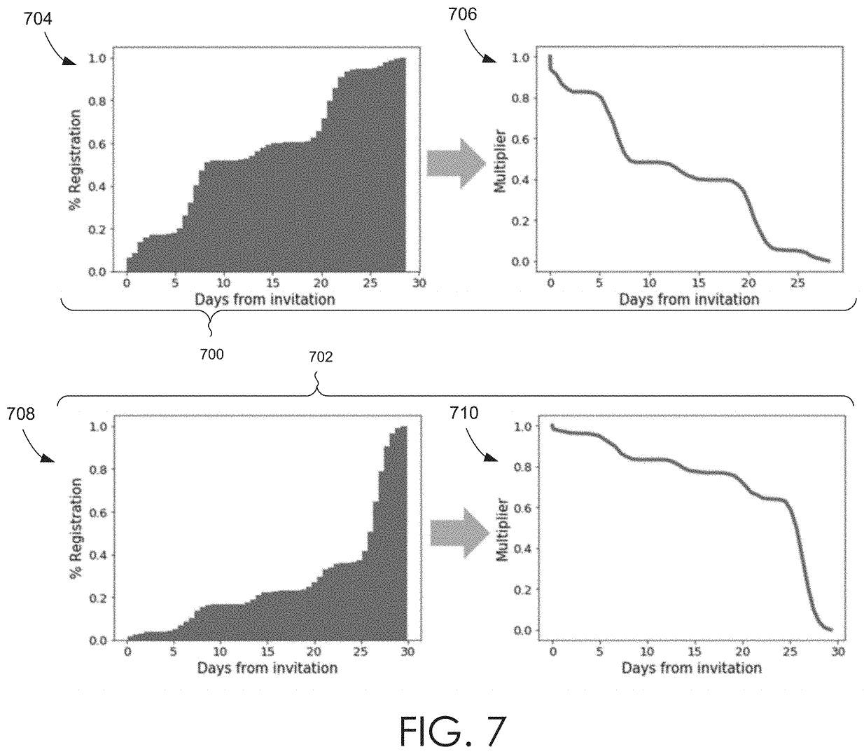

FIG. 7 depicts illustrative expected registration profiles for events, in accordance with various embodiments of the present disclosure. FIG. 7 provides two examples of expected registration profiles for two events: expected registration profile 700 and expected registration profile 702. As depicted, expected registration profile 700 comprises predicted audience behavior histogram 704 and corresponding time-dependent adjustment function 706 (e.g., based on the predicted audience behavior histogram). Expected registration profile 702 comprises predicted audience behavior histogram 708 and corresponding time-dependent adjustment function 710 (e.g., based on the predicted audience behavior histogram).

As illustrated, predicted audience behavior histogram 704 of expected registration profile 700 indicates that roughly 20% of registrations for an event (e.g., that is 28 days away) are expected to happen on or before the 5^{th} day after an invitation to the event is sent, around 50% of registrations for the event are expected to happen on or before the 10^{th} day after the invitation is sent, and over 90% of registrations for an event are expected to happen on or before the 25^{th} day after an invitation to the event is sent. On the other hand, predicted audience behavior histogram 708 of expected registration profile 702 indicates that roughly 5% of registrations for an event (e.g., that is 28 days away) are expected to happen on or before the 5^{th} day after an invitation to the event is sent, around 20% of registrations for the event are expected to happen on or before the 10th day after the invitation is sent, and over 90% of registrations for an event are expected to happen on or before the 25^{th} day after an invitation to the event is sent.

The information in predicted audience behavior histogram 704 and predicted audience behavior histogram 708 can be used to determine corresponding time-dependent adjustment functions (e.g., corresponding time-dependent adjustment function 706 and corresponding time-dependent adjustment function 710). The corresponding time-dependent adjustment function can indicate a fraction of expected invitees of the audience that are expected to register at certain points in time (e.g., based on the predicted audience behavior histogram). In embodiments, to obtain the corresponding time-dependent adjustment functions, an inverse of the predicted audience behavior histogram can be used.

As illustrated, corresponding time-dependent adjustment function 706 of expected registration profile 700 indicates that the time-dependent adjustment function on the 5^{th} day would be around 0.8 (e.g., indicating roughly 20% of registrations are predicted), the time-dependent adjustment function on the 10^{th} day would be around 0.5 (e.g., indicating roughly 50% of registrations are predicted), and the time-dependent adjustment function on the 25^{th} day would be less than 0.1 (e.g., indicating roughly 90% of registrations are predicted). On the other hand, corresponding time-dependent adjustment function 708 of expected registration profile 702 indicates that the time-dependent adjustment function on the 5^{th} day would be around 0.95 (e.g., indicating roughly 5% of registrations are predicted), the time-dependent adjustment function on the 10^{th} day would be around 0.8 (e.g., indicating roughly 20% of registrations are predicted), and the time-dependent adjustment function on the 25^{th} day would be less than 0.1 (e.g., indicating roughly 90% of registrations are predicted).

Information from expected registration profile 700 and expected registration profile 702 can be used, for instance, to generate predicted event outcome for events. Using these profiles, a user can analyze real-time audience behavior leading up to the event. For example, these profiled can be used to generate continuously updated (e.g., in real-time) predicted event outcome based on current audience registrations to adjust a predicted registration over time. In this way, profiles can be used to identify whether a set of invitees to an event are likely to meet an attendance goal set for the event (e.g., based on the real-time audience behavior and predicted audience behavior for the time remaining unit the event occurs). Such information can be used by a user to invite additional invitees if an initial set of invitees are not likely to meet an attendance goal set for the event. Advantageously, this can be performed at a minimal amount of time from when the initial invitations are sent.

For instance, as an illustrative example, using expected registration profile 700, if the event audience is comprised of 500 invitees with the attendance goal of 450 invitees attending; and on the 5^{th} day 130 invitees have registered for the event—the predicted event outcome can indicate a high likelihood of meeting the attendance goal. In particular, by the 5^{th} day roughly 20% of registrations were predicted; if 130 registrations are received by the 5^{th} day, time-dependent adjustment function 706 (e.g., 0.8 at day 5) can be used to indicate what number of the remaining 370 invitees are likely to register for the event in the time remaining until the event occurs. This number can be combined with the real-time audience behavior (e.g., actual registration) to give predicted registrations plus actual registrations. Because the actual 130 registrations received by day 5 is greater than the predicted registrations at day 5, the predicted event outcome can indicate a high likelihood of meeting the attendance goal. On the other hand, if only 50 registrations were received by the 5^{th} day, which is less than the predicted registrations expected by day 5, the predicted event outcome can indicate a likelihood that the attendance goal will not be met. This predicted event outcome provides insight into whether additional invitees should be invited to the event to increase the likelihood of meeting the attendance goal.

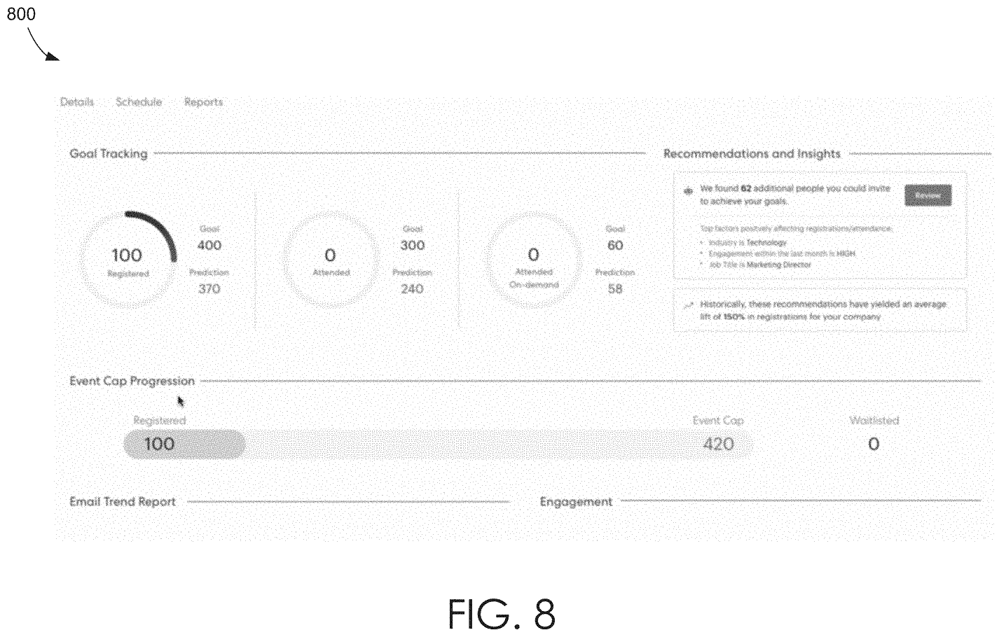

FIG. 8. depicts an illustrative graphical user interface of an attendance optimization system, in accordance with various embodiments of the present disclosure. Attendance optimization system 800 can interact with one or more expected registration profiles to analyze audience behavior as related to an event. Attendance optimization system 800 can provide an indication of a predicted event outcome for the event. The predicted event outcome can indicate a time-based conversion propensity related to the audience of the event. Such a predicted event outcome can also identify a likelihood of meeting an attendance goal set for the event. This likelihood can be based on the predicted audience behavior indicating registration to the event by the audience.

In an embodiment, a predicted event outcome can be used to present an indication as to whether an attendance goal for the event is likely to be met. For instance, a number of invitees that are predicted to register for the event can be displayed. This number of invitees can be based on real-time audience behavior combined with predicted audience behavior. In particular, a number of invitees that have registered for the event (e.g., real-time audience behavior) can be combined with a predicted number of invitees from the audience that are likely to register in the time remaining until the event occurs (e.g., predicted audience behavior). This predicted number of invitees can be displayed as “Prediction” (e.g., 370 as displayed). When this predicted number of invitees is less than the “Goal” it indicates that the expected registration profile predicts that an attendance goal set for the event is not likely to be met. In some embodiments, such a likelihood of meeting an attendance goal set for the event can be indicated using a color. For example, displaying the predicted number of invitees using green can indicate that the current prediction indicates the attendance goal for the event will be met. Displaying the predicted number of invitees using red can indicate that the current prediction indicates the attendance goal for the event will not be met. Such a predicted event outcome can be integrated into and displayed using an event profile.

Having described embodiments of the present invention, an example operating environment in which embodiments of the present invention may be implemented is described below in order to provide a general context for various aspects of the present invention. Referring to FIG. 9, an illustrative operating environment for implementing embodiments of the present invention is shown and designated generally as computing device 900. Computing device 900 is but one example of a suitable computing environment and is not intended to suggest any limitation as to the scope of use or functionality of the invention. Neither should the computing device 900 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a smartphone or other handheld device. Generally, program modules, or engines, including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialized computing devices, etc. Embodiments of the invention may also be practiced in distributed computing environments where tasks are performed by remote-processing devices that are linked through a communications network.

With reference to FIG. 9, computing device 900 includes a bus 910 that directly or indirectly couples the following devices: memory 912, one or more processors 914, one or more presentation components 916, input/output ports 918, input/output components 920, and an illustrative power supply 922. Bus 910 represents what may be one or more busses (such as an address bus, data bus, or combination thereof). Although the various blocks of FIG. 9 are shown with clearly delineated lines for the sake of clarity, in reality, such delineations are not so clear and these lines may overlap. For example, one may consider a presentation component such as a display device to be an I/O component, as well. Also, processors generally have memory in the form of cache. We recognize that such is the nature of the art, and reiterate that the diagram of FIG. 9 is merely illustrative of an example computing device that can be used in connection with one or more embodiments of the present disclosure. Distinction is not made between such categories as “workstation,” “server,” “laptop,” “hand-held device,” etc., as all are contemplated within the scope of FIG. 9 and reference to “computing device.”

Computing device 900 typically includes a variety of non-transitory computer-readable media. Non-transitory Computer-readable media can be any available media that can be accessed by computing device 900 and includes both volatile and nonvolatile media, removable and non-removable media. By way of example, and not limitation, non-transitory computer-readable media may comprise non-transitory computer storage media and communication media.

Non-transitory computer storage media include volatile and nonvolatile, removable and non-removable media implemented in any method or technology for storage of information such as computer-readable instructions, data structures, program modules or other data. Non-transitory computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 900. Non-transitory computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 912 includes computer storage media in the form of volatile and/or nonvolatile memory. As depicted, memory 912 includes instructions 924. Instructions 924, when executed by processor(s) 914 are configured to cause the computing device to perform any of the operations described herein, in reference to the above discussed figures, or to implement any program modules described herein. The memory may be removable, non-removable, or a combination thereof. Illustrative hardware devices include solid-state memory, hard drives, optical-disc drives, etc. Computing device 900 includes one or more processors that read data from various entities such as memory 912 or I/O components 920. Presentation component(s) 916 present data indications to a user or other device. Illustrative presentation components include a display device, speaker, printing component, vibrating component, etc.

I/O ports 918 allow computing device 900 to be logically coupled to other devices including I/O components 920, some of which may be built in. Illustrative components include a microphone, joystick, game pad, satellite dish, scanner, printer, wireless device, etc.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

From the foregoing, it will be seen that this disclosure in one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in a limiting sense, and the scope of embodiments is defined by the appended claims and their equivalents.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method, comprising:
receiving event metadata that corresponds to an event;
generating an expected registration profile based on the event metadata that indicates predicted audience behavior for the event;
analyzing, using the expected registration profile, real-time audience behavior of an audience associated with the event; and
determining, based on the analyzed real-time audience behavior, a predicted event outcome for the event that indicates a time-based conversion propensity related to the audience.

2. The computer-implemented method of claim 1, further comprising:
comparing a set of event features related to the event with one or more event features;
determining, based on the comparison, one or more events that correlate to the event; and
identifying the event metadata related to the one or more events that correlate to the event.

3. The computer-implemented method of claim 1, further comprising:
presenting a real-time indication related to a likelihood of meeting an attendance goal set for the event based on the predicted event outcome.

4. The computer-implemented method of claim 3, further comprising:
updating the real-time indication related to the likelihood of meeting an attendance goal set for the event based on the real-time audience behavior.

5. The computer-implemented method of claim 1, wherein the expected registration profile comprises a predicted audience behavior histogram and a corresponding time-dependent adjustment function.

6. The computer-implemented method of claim 1, wherein analyzing the real-time audience behavior of the audience comprises:
determining an amount of time from an invitation being sent to the audience related to the event; and
applying a time-dependent adjustment function to the predicted audience behavior based on the amount of time.

7. The computer-implemented method of claim 1, wherein determining the predicted event outcome comprises:
adjusting the predicted audience behavior based on an amount of time from an invitation being sent to the audience related to the event; and
combine the real-time audience behavior with the adjusted predicted audience behavior.

8. The computer-implemented method of claim 1, further comprising:
based on the predicted event outcome of the audience indicating a likelihood of failure to meet an attendance goal set for the event, identifying a supplemental audience to invite to the event.

9. The computer-implemented method of claim 1, further comprising:
based on the predicted event outcome of the audience indicating a likelihood of failure to meet an attendance goal set for the event, sending additional invitations to a supplemental audience.

10. The computer-implemented method of claim 9, further comprising:
generating an updated expected registration profile based on the event metadata that indicates an updated predicted audience behavior for the event based on a combination of the predicted audience behavior for the audience and an additional predicted audience behavior for the supplemental audience;
analyzing, using the updated expected registration profile, an updated real-time audience behavior of the audience and the supplemental audience; and
determining an updated predicted event outcome for the event that indicates the time-based conversion propensity related to the audience and the supplemental audience.

11. One or more computer storage media storing computer-useable instructions that, when used by one or more computing devices, cause the one or more computing devices to perform operations comprising:
receiving an expected registration profile corresponding to predicted audience behavior for an event;
analyzing, using the expected registration profile, actual audience behavior of an audience associated with the event;
determining a predicted event outcome for the event that indicates a time-based conversion propensity related to the audience, wherein the predicted event outcome is based on the expected registration profile and the actual audience behavior; and
presenting a real-time indication related to a likelihood of meeting an attendance goal set for the event based on the predicted event outcome.

12. The one or more computer storage media of claim 11, the operations further comprising:
comparing a set of event features related to the event with one or more event features;
determining, based on the comparison, one or more events that correlate to the event; and
identifying event metadata related to the one or more events that correlate to the event; and
generating the expected registration profile based on the event metadata.

13. The one or more computer storage media of claim 11, the operations further comprising:
analyzing the post-purchase interaction to determine a motivation of the customer to buy the purchased product.

14. The one or more computer storage media of claim 11, the operations further comprising:
updating the real-time indication related to the likelihood of meeting an attendance goal set for the event based on the real-time audience behavior.

15. The one or more computer storage media of claim 11, wherein the expected registration profile comprises a predicted audience behavior histogram and a corresponding time-dependent adjustment function.

16. The one or more computer storage media of claim 11, wherein analyzing the actual audience behavior comprises:
determining an amount of time from an invitation being sent to the audience related to the event; and
applying a time-dependent adjustment function to the predicted audience behavior based on the amount of time.

17. The one or more computer storage media of claim 11, wherein determining the predicted event outcome comprises:
adjusting the predicted audience behavior based on an amount of time from an invitation being sent to the audience related to the event; and
combine the real-time audience behavior with the adjusted predicted audience behavior.

18. The one or more computer storage media of claim 11, wherein determining the predicted event outcome comprises:
based on the predicted event outcome of the audience indicating a likelihood of failure to meet an attendance goal set for the event, sending additional invitations to a supplemental audience;
generating an updated expected registration profile based on the event metadata that indicates an updated predicted audience behavior for the event based on a combination of the predicted audience behavior for the audience and an additional predicted audience behavior for the supplemental audience;
analyzing, using the updated expected registration profile, an updated real-time audience behavior of the audience and the supplemental audience; and
determining an updated predicted event outcome for the event that indicates the time-based conversion propensity related to the audience and the supplemental audience.

19. A computing system comprising:
means for generating an expected registration profile that indicates predicted audience behavior for an event;
means for analyzing real-time audience behavior of an audience associated with the event using the expected registration profile; and
means for determining a predicted event outcome for the event that indicates a time-based conversion propensity related to the audience based on the expected registration profile and real-time audience behavior.

20. The computing system of claim 19, further comprising:
means for presenting a real-time indication related to a likelihood of meeting an attendance goal set for the event based on the predicted event outcome.
